(19) United States
(12) Patent Application Publication
(10) Pub. No.: US 2008/0034539 A1
(43) Pub. Date: Feb. 14, 2008

(54) ADJUSTABLE REFRIGERATOR DOOR HINGE

(75) Inventors: Daniel W. Lyvers, Greenwood, MS (US); Alan Clark Webb, Grenada, MS (US); Robert David Rendel, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/459,722

(22) Filed: Jul. 25, 2006

(51) Int. Cl. E05D 7/04

(52) U.S. Cl. 16/238

(57) ABSTRACT

A refrigerator door hinge for a refrigerator having a door and a body frame includes a plate and a first bushing that provides horizontal adjustments and that is inserted into a hole in the plate. The hinge further includes a second bushing that provides vertical adjustments and that is inserted in an opening of the first bushing. The first bushing is further inserted into a base that includes an adjusting screw. Horizontal adjustments of the door relative to the body frame are made by rotating the adjusting screw. Vertical adjustments of the door relative to the body frame are made by rotating the second bushing.

### FIELD OF THE INVENTION

One embodiment of the present invention is directed to a refrigerator. More particularly, one embodiment of the present invention is directed to an adjustable door hinge for a refrigerator.

### BACKGROUND INFORMATION

Generally, a refrigerator door is rotatably engaged with a body frame of a refrigerator, so that the refrigerator is opened or closed by the rotational operation of the refrigerator door. The refrigerator door is engaged to the refrigerator body frame by a support member or door hinge, which is installed in a lower or upper portion of the refrigerator body frame for supporting the refrigerator door.

Some known door hinges allow for fairly easy vertical (i.e., up and down) adjustment of the door relative to the body frame. This is desirable to properly line up the edges of the door with the body frame when installing a refrigerator.

Some known types of refrigerators are built into a wall cabinet and generally include a panel type door which is aligned in close proximity to the wall panels so that only a very narrow gap exists between the refrigerator door and the adjoining wall panels. In order to maintain the aesthetic characteristics of the refrigerator, the panel type door needs to be at the approximately flush with the wall panels. However, known door hinges do not allow for easy horizontal (i.e., front and back) adjustments of the door relative to the body frame. Therefore, when a refrigerator is installed and the door is not flush with the wall panels, an installer typically must physically tilt the refrigerator and manually move the hinges to provide horizontal adjustment. This is very time consuming and difficult.

Based on the foregoing, there is a need for an improved refrigerator door hinge that allows for both vertical and horizontal adjustments.

### SUMMARY OF THE INVENTION

One embodiment of the present invention is a refrigerator door hinge for a refrigerator having a door and a body frame. The hinge includes a plate and a first bushing that provides horizontal adjustments and that is inserted into a hole in the plate. The hinge further includes a second bushing that provides vertical adjustments and that is inserted in an opening of the first bushing. The first bushing is further inserted into a base that includes an adjusting screw. Horizontal adjustments of the door relative to the body frame are made by rotating the adjusting screw. Vertical adjustments of the door relative to the body frame are made by rotating the second bushing.

### BRIEF DESCRIPTION OF THE DRAWINGS

FIG. 1 is a front view of a refrigerator that implements one embodiment of the present invention.

FIG. 2 is a perspective view of a prior art door hinge.

FIG. 3 is a perspective view of a refrigerator door hinge in accordance with one embodiment of the present invention.

FIG. 4 is a side view of a refrigerator with a hinge in accordance with one embodiment of the present invention.

FIG. 5 is a cut-away side view of a hinge in accordance with one embodiment of the present invention.

### DETAILED DESCRIPTION

One embodiment of the present invention is a refrigerator door hinge that allows for both vertical and horizontal adjustments.

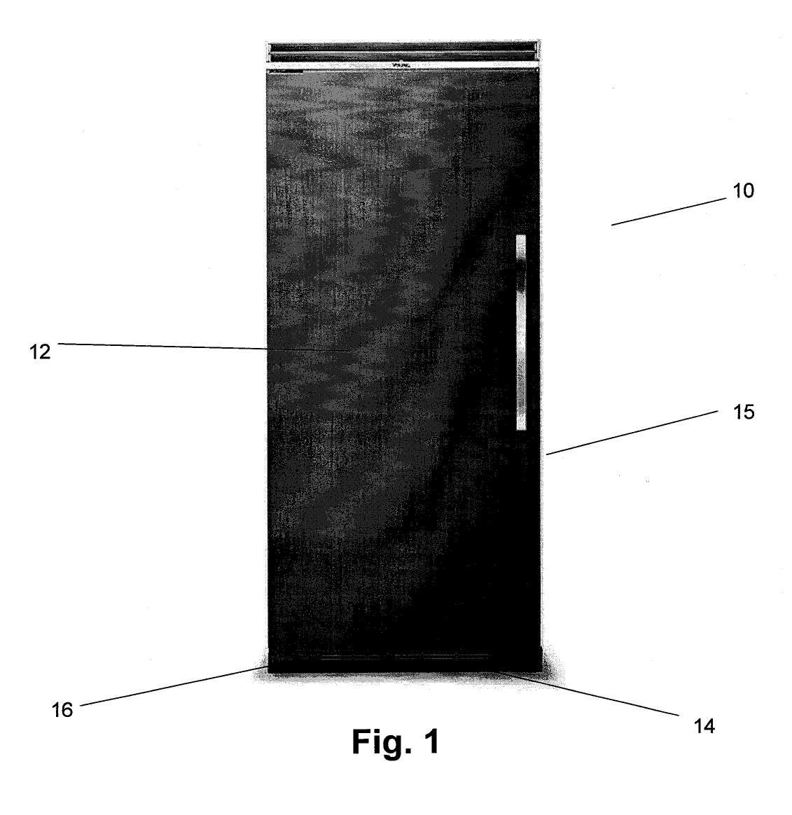

FIG. 1 is a front view of a refrigerator 10 that implements one embodiment of the present invention. Refrigerator 10 includes a door 12, a body frame 15 located behind door 12, a toe grill assembly 14 and a door hinge 16. Door 12 includes an axis pin that is inserted in door hinge 16 and that allows door hinge 16 to support door 12 and allow it to open along its axis. Refrigerator 10 is a built-in type of refrigerator that is designed to be flush with adjacent wall panels. However, embodiments of the invention can be implemented on any type of refrigerator or refrigerator/freezer combo, and the term “refrigerator” encompasses any of these varieties.

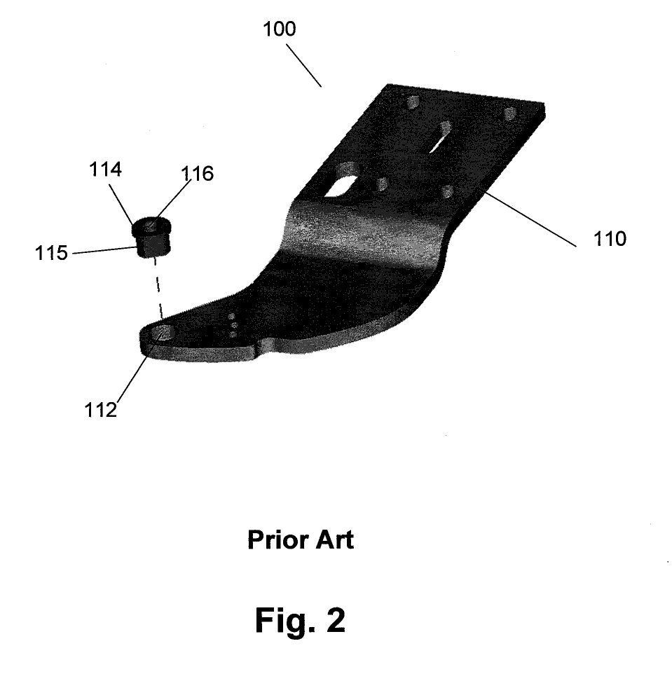

FIG. 2 is a perspective view of a prior art door hinge 100. Door hinge 100 includes a plate 110 that is mounted on the refrigerator body frame. Hinge 100 further includes a threaded hole 112 that is adapted to receive a bushing 114 that includes external threads 115. Bushing 114 can be adjusted up and down within hole 112 by rotating bushing 114. The axis pin from the refrigerator door is inserted into opening 116 of bushing 114. Therefore, the rotation of bushing 114 causes the door to be adjusted in the vertical direction. However, door hinge 100 does not provide an easy way to perform horizontal adjustments.

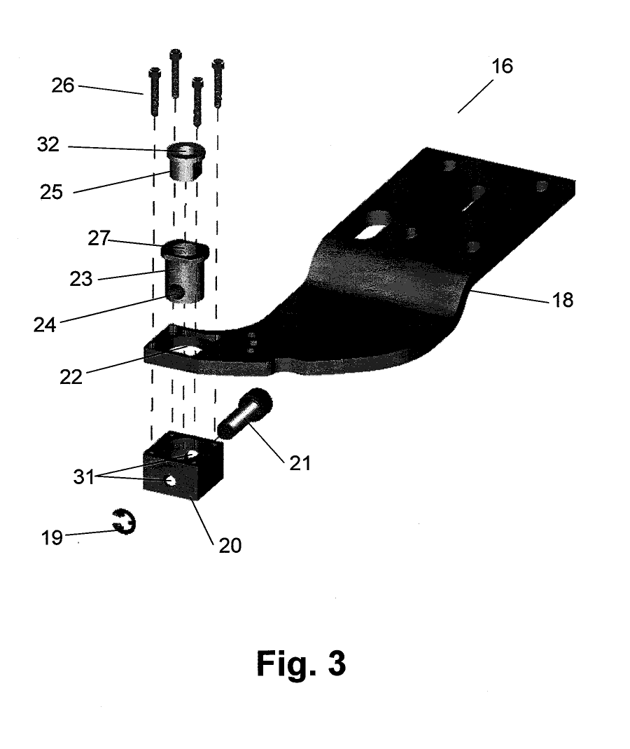

FIG. 3 is a perspective view of the refrigerator door hinge 16 in accordance with one embodiment of the present invention. Hinge 16 includes a plate 18 that is mounted on refrigerator body frame 15. Plate 18 further includes a hole 22 that is adapted to receive a horizontal adjustment bushing 23. Bushing 23 has an internally threaded opening 27 and includes a channel 24 through its solid base. Channel 24 also includes internal threads. Bushing 23 is inserted into a base 20 and is held in place by a socket head screw 21 which is inserted through holes 31 of base 20 and through channel 24. Base 20 is coupled to plate 18 by screws 26. Socket head 21 is coupled to an e-clip retainer 19.

Hinge 16 further includes a vertical adjustment bushing 25 that is inserted within horizontal adjustment bushing 23 through opening 27. Vertical bushing 25, like bushing 114 of FIG. 2, is externally threaded and can be adjusted up and down relative to horizontal bushing 23 through rotation. Vertical bushing 25 includes an opening 32 that receives the axis pin of refrigerator door 12.

In operation, hinge 16 permits vertical adjustments of door 12 relative to body frame 15 of refrigerator 10 by rotating bushing 25, which causes bushing 25 to move up and down relative to bushing 23 and plate 18. Hinge 16 permits horizontal adjustments of door 12 relative to body frame 15 of refrigerator 10 by rotating screw 21, which causes bushing 23 (and bushing 25) to move back and forth within hole 22 of plate 18.

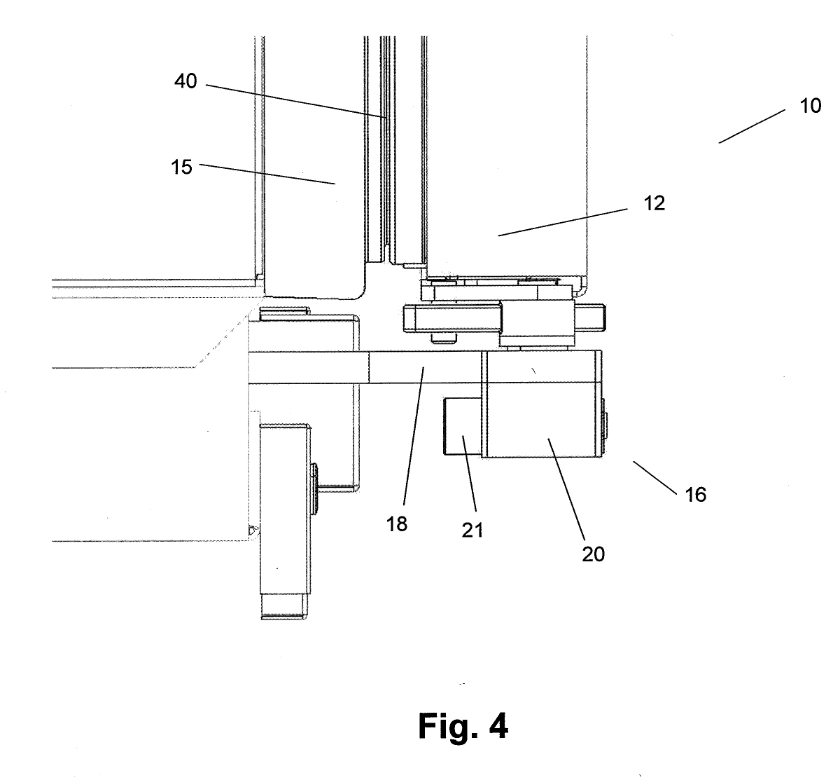

FIG. 4 is a side view of refrigerator 10 with hinge 16 in accordance with one embodiment of the present invention. A gasket or seal 40 separates body frame 15 from door 12.

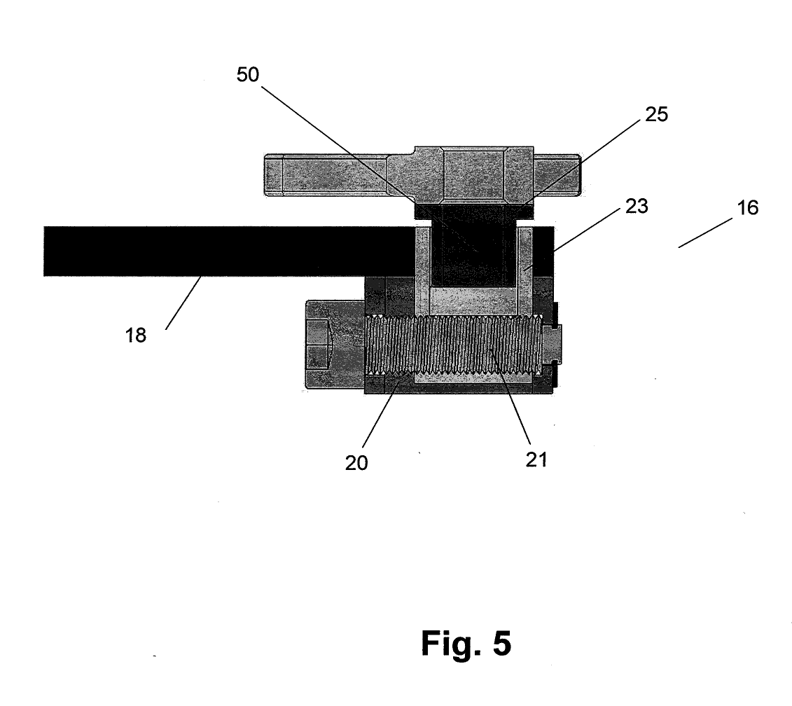

FIG. 5 is a cut-away side view of hinge 16 in accordance with one embodiment of the present invention. As shown, axis pin 50 of door 12 is inserted in vertical bushing 25, which is inserted in horizontal bushing 23. Bushing 23 is inserted in base 20, and is moved horizontally relative to base 20 and plate 18 by rotation of screw 21.

As disclosed, embodiments of the present invention are a refrigerator door hinge that allows for both vertical and horizontal adjustments of the door relative to the refrigerator body frame.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A refrigerator door hinge comprising:
a plate having a hole;
a first bushing inserted in the hole and coupled to a base, said bushing having a first opening;
an adjusting device inserted in the base and the first bushing; and
a second bushing inserted in the first opening, said second bushing having a second opening.

2. The refrigerator door hinge of claim 1, wherein said first bushing comprises a threaded channel, and said adjusting device is inserted through said channel.

3. The refrigerator door hinge of claim 2, wherein said adjusting device is a threaded screw, and a rotation of said threaded screw provides a horizontal adjustment.

4. The refrigerator door hinge of claim 1, wherein said first opening is internally threaded, and said second bushing is externally threaded.

5. The refrigerator door hinge of claim 4, wherein a rotation of said second bushing provides a vertical adjustment.

6. The refrigerator door hinge of claim 1, wherein the second opening is adapted to receive a refrigerator door axis pin.

7. The refrigerator door hinge of claim 3, wherein the horizontal adjustment moves a refrigerator door back and forth relative to a refrigerator body frame.

8. The refrigerator door hinge of claim 5, wherein the vertical adjustment moves a refrigerator door up and down relative to a refrigerator body frame.

9. A refrigerator comprising:
a frame;
a door having an axis of rotation;
a hinge coupled to said door and frame, wherein said hinge comprises:
a plate having a hole;
a first bushing inserted in the hole, said bushing having a first opening;
an adjusting device coupled to said first bushing; and
a second bushing inserted in the first opening, said second bushing having a second opening.

10. The refrigerator of claim 9, wherein said first bushing comprise a threaded channel, and said adjusting device is inserted through said channel.

11. The refrigerator of claim 10, wherein said adjusting device is a threaded screw, and a rotation of said threaded screw provides a horizontal adjustment of said door relative to said casing.

12. The refrigerator of claim 11, wherein said second bushing and said adjusting device are coupled to a base.

13. The refrigerator of claim 9, wherein said first opening is internally threaded, and said second bushing is externally threaded.

14. The refrigerator of claim 13, wherein a rotation of said second bushing provides a vertical adjustment of said door relative to said casing.

15. The refrigerator of claim 9, wherein the second opening is adapted to receive a pin coupled to said axis of rotation.

16. A door hinge comprising:
a plate;
a first bushing coupled to said plate; and
a second bushing coupled to said first bushing.

17. The door hinge of claim 16, wherein said first bushing comprises internal threads, and said second bushing comprises external threads.

18. The door hinge of claim 16, wherein said first bushing comprises an internally threaded channel, and said door hinge further includes a base coupled to said first bushing.

19. The door hinge of claim 18, further comprising a screw inserted in the base and the threaded channel.

20. The door hinge of claim 18, wherein said door hinge can be adjusted horizontally by rotating the screw, and can be adjusted vertically by rotating said second bushing.
